(19) United States
(12) Patent Application Publication
(10) Pub. No.: US 2014/0068016 A1
(43) Pub. Date: Mar. 6, 2014

(54) System and Method for Web Application Acceleration

(71) Applicant: Greg Howett, Berkshire (GB)

(72) Inventor: Greg Howett, Berkshire (GB)

(21) Appl. No.: 14/013,007

(22) Filed: Aug. 28, 2013

Related U.S. Application Data
(60) Provisional application No. 61/694,247, filed on Aug. 28, 2012.

(51) Int. Cl. H04L 29/06

(52) U.S. Cl. CPC H04L 67/42
USPC 709/219

(57) ABSTRACT

Disclosed is a method of delivering a web page to a user accessing a browser, comprising: providing requested web pages to a client for analyzing content of the pages; adding scripted language code and executing; requesting a template page from a web/application server; creating a delta by comparing content of the pages; and producing a web page based on the delta.

### CROSS REFERENCE TO RELATED APPLICATION

The present application is related to Provisional Patent Application entitled “System and Method for Web Application Acceleration,” filed 28 Aug. 2012 and assigned filing No. 61/694,247, incorporated herein by reference in its entirety.

### FIELD OF THE INVENTION

The present invention provides a system and method for accelerating web page access for a user.

### BACKGROUND OF THE INVENTION

A problematic “gap” has been recognized in the present state of the art between synchronous WAN acceleration technology and asynchronous ADC technology. However, conventional methods of improving WAN speed have the shortcomings that a solution would be asynchronous, and would require a client for implementation. In addition, security policies and physical accessibility issues would make it difficult to install required software and/or hardware at the client. What is needed is a method for providing similar or greater acceleration levels for both dynamic and static web applications than may be achieved by synchronous WAN acceleration products, but without the requirement that a specific client be installed by the user.

In particular, what is needed is a technique that will work in a range of environments, and with the majority of browsers currently in use. Preferably, greater implementation flexibility on a more cost effective basis would be provided, in comparison to conventional systems in which, and preferably, there would be no requirement for the installation of client side software or hardware.

### BRIEF SUMMARY OF THE INVENTION

In one aspect of the present invention, a method of delivering a web page to a user accessing a browser, the method comprising: requesting a first web page from a web/application server; providing the requested web page to a client for analyzing content of the requested web page; adding scripted language code to the content by the client; executing the scripted language code by the client; requesting a template page from the web/application server; requesting a second web page from the web/application server; creating a delta by comparing content of the second web page with the content of the first web page to determine difference from the first web page to the second web page; sending the difference from the first web page to the second web page to the client; producing a web page using the difference from the first web page to the second web page and the template web page; and delivering the produced web page to the user.

In another aspect of the present invention, a system for accelerating web page access for a user comprised: a web/application server for responding to a request for a first web page and a second web page; and a client in communication with the web/application server, the client for analyzing content of the requested web page and adding scripted language code to the analyzed content.

The additional features and advantage of the disclosed invention is set forth in the detailed description which follows, and will be apparent to those skilled in the art from the description or recognized by practicing the invention as described, together with the claims and appended drawings.

### BRIEF DESCRIPTION OF THE DRAWINGS

The foregoing aspects, uses, and advantages of the present invention will be more fully appreciated as the same becomes better understood from the following detailed description of the present invention when viewed in conjunction with the accompanying figures, in which:

FIG. 1 is a functional diagram illustrating an exemplary embodiment of a web application acceleration system, in accordance with the present invention; and

FIG. 2 a flow diagram illustrating a method for improving the speed of web surfing, when used in the web application acceleration system of FIG. 1.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention.

In accordance with the disclosed method, a user may access a web page using a browser, as is known in the art. In the background, the user is sent a client application in the form of a scripted language, such as JavaScript, for example. This activity is transparent to the user. However, the JavaScript application will then manage communication between the user and a server, as the user continues to access web pages of his choice.

Concurrently, a client functions to determine the difference, or “delta,” between successive web pages requested by the user. The server component functions to send to the user only the difference between the content in a current web page, and the content in the next page requested by the user. The data for the delta between successive web pages is typically very small, in comparison to the data required for an entire web page. In addition, one or more templates may be transparently sent to the client from the server. As used herein, a template comprises a page that is similar to the pages required for the website.

The JavaScript client can also provide other acceleration and application delivery techniques to the user including, but not limited to, content manipulation, that is, changing the content of the page in accordance with pre-specified criteria. This technique may be used to provide other solutions such as, for example, JS and CSS consolidation, URL rewriting, and refactoring the code. Refactoring code includes moving code about so the respective web page can be rendered faster by the user browser.

The advantage of performing such manipulation on the JavaScript client, rather than performing manipulation on the server, is that of performance and resource. Complex page rewriting can be server intensive. However, modern clients have sufficient CPU resources such that it becomes more efficient to perform these acceleration techniques, in full or in part, on the client.

In addition, the client can also provide management and real end user performance information to the server component. The server component can be a load balancing appliance (LBA), an Application Delivery Controller (ADC), proxy, or a stand-alone application.

This performance information includes but is not limited to: (i) time to first byte, (ii) time taken to render the web page; (iii) time taken to produce the web page form the delta, and (iv) time to last byte. In addition to recording this information, the server may use the recorded information to change the acceleration techniques used.

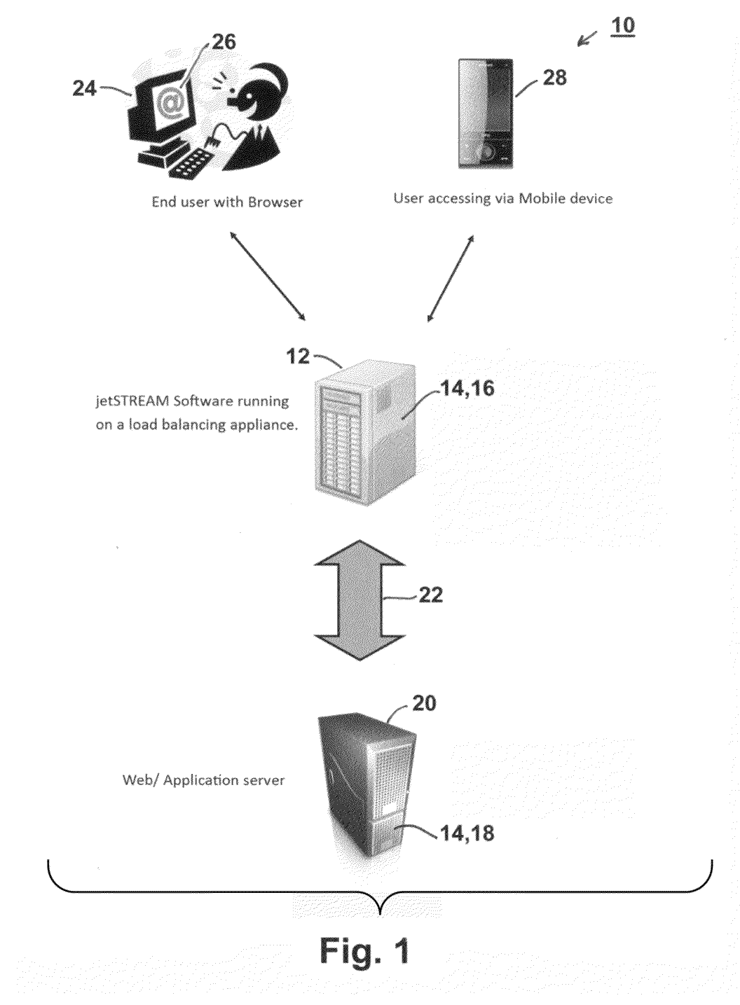

As shown in FIG. 1, a web application acceleration system 10 suitable for implementing the disclosed software application 14 may include an LBA/ADC 12 in communication with an application/webserver 20 via the Internet 22. A user may access a specific website 26 using a favorite browser to access the application/webserver 20 via a computer, laptop, or pad 24. Alternatively, the user may access the desired website 26 via a mobile communication device 28, as shown.

A server component 16 of the disclosed software application 14 may be installed as a proxy, on the load balancing appliance (LBA) Application Delivery Controller (ADC) 12, or as stand-alone software 18 installed on the application/webserver 20. In an exemplary embodiment, the disclosed software application 14, the server component 16, and/or the stand-alone software 18 may be stored in a memory or on a computer-readable medium, as is well-known in the relevant art. A client component of the disclosed software application 14 may be sent and run within the client's browser in a manner transparent to the user. The client may also comprise a compiled application that can be run on a server for machine-to-machine commination, or may be downloaded as a browser plugin.

The disclosed software application 14 functions to calculate and send “deltas” to clients. In addition, the disclosed software application 14 may also send templates required to build templates required to build a specified web page, as well as any instructions for content re-writing or other client-side optimization, as described in greater detail below. That is, the disclosed software application 14 controls and accelerates the browsing information provided to the user, whereby (i) the application/webserver 20 sends web pages from the website 26 to the LBA/ADC 12 running the disclosed software application 14, and (ii) the web information is then provided to the user.

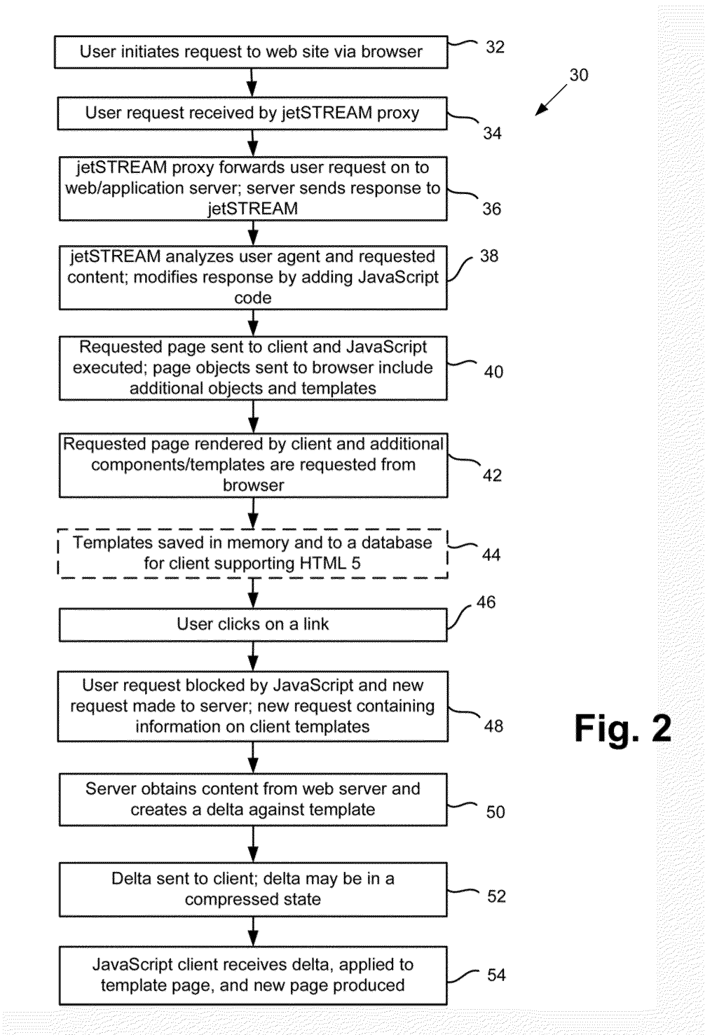

FIG. 2 shows a flow diagram 30 illustrating implementation of the disclosed software application 14, herein denoted as jetSTREAM application 14 for convenience, the jetSTREAM application 14 advantageously accessed by the user's browser for improving the speed of web surfing. The client or user may make a request to the web site 26, at step 32. The request may be received by a jetSTREAM proxy, at step 34. The proxy may forward the user request on to the web/application server 20, and the user request may be received by the jetSTREAM application 14, at step 36.

The jetSTREAM application 14 may analyze the user agent and the content requested by the user, at step 38. The jetSTREAM application 14 may then modify the response by adding JavaScript code. The resultant page(s) may be sent to the client, at step 40, and the JavaScript may be executed. The one or more pages sent to the client browser preferably include one or more additional objects, such as, for example, a template.

The one or more pages received by the LBA/ADC 12 are rendered by the client, at step 42, and there may be a request for additional components from the browser such as, for example, the template. The template may be saved in memory, at step 44, and may be stored to a database if the LBA/ADC 12 supports HTML 5. The user may click on a link, at step 46, and the user request may then be blocked by the JavaScript, at step 48. A new request may be made to the application/webserver 20, where the new request comprises information on the one or more templates that the LBA/ADC 12 may have.

The LBA/ADC 12 server may use the content received from the application/webserver 20, at step 50, and create a “delta” by comparing the content with a template entry. The data may be sent to the client in a compressed format, at step 52. The JavaScript client, or the LBA/ADC 12, may then receive the delta, at step 54, and produce a new page for the user.

The jetSTREAM application 14 “remembers” the content that the user has been sent, and selects the most similar page or data segment against which the delta has been run. This process may use advanced Vector Space Analysis (VPA) or other AI techniques, as known in the relevant art.

The jetSTREAM application 14 may also send template pages to the user while the user may be viewing other content. This is a technique of sending content to users in the background is typically referred to in the relevant art as “pre fetch.” In the disclosed system and method, the pages and content sent by the jetSTREAM application 14 are not designed to be directly used like an image that could be used in a pre-fetch situation. The template sent is designed to be similar to what the user may require. To make the template optimal for use, a delta may be applied to the template itself.

As used herein, the term “template page’ refers to a page that has the most similarities to the content the user wants to have next. For example, if the template page were the same as the subsequent web page required by the user, then the delta would be effectively zero, and the jetSTREAM application 14 would need to send almost no additional data to the user to generate the subsequent web page. Accordingly, the subsequent page would load almost instantly. On the other hand, if the template and the required page comprise essentially completely different data, then the data provided via the delta may be almost the same amount of data in the required web page.

It can be appreciated by one skilled in the relevant art that the jetSTREAM application 14 functions to choose the “best web page” to run the delta against. For example, the best web page may comprise: (i) any previous web page, or part of a web page, that the user has visited; (ii) the last page visited by the user; (iii) any template page; or (iv) a built-in template page.

The jetSTREAM application 14 recognizes key business applications, for example, such as SharePoint, Oracle, and SAP. In a preferred embodiment, the jetSTREAM application 14 will use the most appropriate dictionary for a particular application, once the particular application is recognized.

In a preferred embodiment, the jetSTREAM application 14 can run in three modes. (1) Basic compression is the starting point. (2) If the client/server can support RFC3284, then RFC3284 can be used. (3) If the Client can run the jetSTREAM application 14, then the jetSTREAM application 14 will be used.

In addition, SDCH can be used if Chrome, or another compatible client such as Microsoft Internet Explorer, connects with SDCH software installed. As can be appreciated by one skilled in the art, a chrome IE plugin can provide this functionality in some cases.

The disclosed method is to be distinguished from prior art methods in that the teachings of the prior art send entire web pages in response to a client request, because of the way in which HTTP functions, even if adjacent web pages are substantially similar. Thus, only static content can typically be reliably cached by the client.

It has been observed that web applications can achieve a data reduction of from about 90% to about 99% using the jetSTREAM application 14. The corresponding increase for the web application speed can be significantly and proportionally faster. Correspondingly in the context to web applications, there may not be a need at each end for conventional Synchronous WAN Optimization controllers.

The jetSTREAM application 14 can read optimization instructions from the templates. These instructions provide information to the client specific to the jetSTREAM application 14. This information may include, for example, information on content substitution and page refactoring, or other information without limitation. For example, such information may specify that “http://xyz” be changed to “http://123.” In addition, the template may contain information on the performance statistics that the jetSTREAM application 14 may report back to the application/webserver 20.

The jetSTREAM application 14 can be taken a step further by using advanced Artificial Intelligence (AI) techniques to predict the content that the user may desire. Such techniques include, for example: Neural Networks, Fuzzy Logic, and Vector Space Analysis. Basically, the AI will generate a unique template page that will have a high probability of delivering the most nearly similar content to what the user is going to require next. This content is then sent to the software plugin in the background—meaning that the content is ready, and waiting, for the user who requests the content.

As this invention is primarily designed for dynamic content, that is, web pages that may be different every time the web pages are requested, the use of the URL for the purpose of pre-fetching may not be adequate. Identical URLs could still result in very different content being sent. Accordingly, the disclosed method will profile the actual content sent and use this profiling technique to build the objects for pre-fetch. For example if a user is sent content that looks like ‘X’ and then content that looks like ‘Y’, then is it likely that the content the user wants next will look like ‘Z’. As the disclosed method is used with deltas, the subsequent web page does not need to be an exact replica of the actual web page sent by the application/webserver 20, but just “close,” so that the deltas are small.

Although the present invention is described with regard to a “computer” on a “computer network”, it should be noted that optionally any device featuring a data processor and/or the ability to execute one or more instructions may be described as a computer, including but not limited to a PC (personal computer), a server, a minicomputer, a pad, a cellular telephone, a smart phone, a PDA (personal data assistant), a pager, TV decoder, game console, digital music player, ATM (machine for dispensing cash), POS credit card terminal (point of sale), electronic cash register. Any two or more of such devices in communication with each other, and/or any computer in communication with any other computer may optionally comprise a “computer network.”

It is to be further understood that the description herein is only exemplary of the invention, and is intended to provide an overview for the understanding of the disclosed web application acceleration system. The accompanying drawings are included to provide a further understanding of various features and embodiments of the method of the invention which, together with the description serve to explain the principles and operation of the invention.

What is claimed is:

1. A method of delivering a web page to a user accessing a browser, said method comprising the steps of:
requesting a first web page from a web/application server;
providing said requested web page to a client for analyzing content of said requested web page;
adding scripted language code to said content by said client;
executing said scripted language code by said client;
requesting a template page from said web/application server;
requesting a second web page from said web/application server;
creating a delta by comparing content of said second web page with said content of said first web page to determine difference from said first web page to said second web page;
sending said difference from said first web page to said second web page to said client;
producing a web page using said difference from said first web page to said second web page and said template web page; and
delivering said produced web page to the user.

2. The method of claim 1 wherein said scripted language comprises JavaScript.

3. The method of claim 1 further comprising the step of, if said client supports HTML 5, said template page is saved in memory.

4. The method of claim 1 wherein said step of sending said difference from said first web page to said second web page to said client comprises the step of placing said difference from said first web page to said second web page into a compressed state before being sent to said client.

5. A system for accelerating web page access for a user comprising:
a web/application server for responding to a request for a first web page and a second web page; and
a client in communication with said web/application server, said client for analyzing content of said requested web page and adding scripted language code to said analyzed content.

6. The system of claim 5 wherein said client comprises a load balancing appliance.

7. The system of claim 5 wherein said client further functions to execute said scripted language code to produce a web page.

8. A computer readable medium having stored therein executable instructions operable to cause an electronic processor to perform a method comprising the steps of:
requesting a first web page from a web/application server;
providing said requested web page to a client for analyzing content of said requested web page;
adding scripted language code to said content by said client;
executing said scripted language code by said client;
requesting a template page from said web/application server;
requesting a second web page from said web/application server;
creating a delta by comparing content of said second web page with said content of said first web page to determine difference from said first web page to said second web page;
sending said difference from said first web page to said second web page to said client; and
producing a web page using said difference from said first web page to said second web page and said template web page; and
delivering said produced web page to the user.

9. The computer readable medium of claim 8 wherein said scripted language comprises JavaScript.

10. The computer readable medium of claim 8 having stored therein executable instructions operable to cause an electronic processor to perform the additional step of, if said client supports HTML 5, said template page is saved in memory.
